(19) United States
(12) Patent Application Publication
(10) Pub. No.: US 2017/0274562 A1
(43) Pub. Date: Sep. 28, 2017

(54) MATRIX-PRODUCTION CARRIER

(71) Applicant: DermaGenesis, LLC, Miami, FL (US)

(72) Inventors: David Tumey, Coral Springs, FL (US); Derek Cox, Miami, FL (US); Jessica Bills, Miami, FL (US)

(21) Appl. No.: 15/469,629

(22) Filed: Mar. 27, 2017

Related U.S. Application Data
(60) Provisional application No. 62/313,840, filed on Mar. 28, 2016.

(51) Int. Cl. B29C 33/38; B33Y 80/00

(52) U.S. Cl. CPC B29C 33/3828; B33Y 80/00; B29C 33/3842; B29K 2855/02; B29K 2067/046

(57) ABSTRACT

Based on dimensions and configurations of a dermal wound on a patient, a carrier is custom-made, preferably by 3D printing, to include a cavity that is duplicative of the specific wound. When the custom-made carrier is used to contain slurry, and the slurry-containing carrier undergoes processing steps (such as freeze-drying in a lyophilization chamber), a matrix is formed that, when removed from the carrier and put into the wound of the patient for whom the carrier was custom-made, fills the wound volume.

### FIELD OF THE INVENTION

The invention relates to technology in support of tissue grafting, and more particularly, skin grafting.

### BACKGROUND OF THE INVENTION

Recently, new technology has been invented by David Tumey and Sandra Berriman in which customized skin grafts are produced from harvested living cells. See U.S. 20150140058 published May 21, 2015; U.S. 20150139960 published May 21, 2015; U.S. 20150366655 published Dec. 24, 2015. An aspect of making skin grafts from harvested cells has been to print (via a 3-D printer) harvested cells onto a pre-constructed holey base or “matrix”. For example, a substrate can be constructed by 3-D-printing sheets of a biosorbable material integrated with a collagen matrix. In one approach, prefab same-size sheets of collagen matrix with or without a honeycomb substrate can be trimmed to a shape of a wound. Custom-printing a collagen matrix would be another approach, but can add further time and complexity.

### SUMMARY OF THE INVENTION

An objective of the invention is to provide methods of producing matrices useable in the production of tissue grafts made from harvested living cells. The invention is especially directed to producing matrices useable in production of skin grafts; matrices useable in production of other tissue grafts, such as bone grafts, etc., also are within the scope of the invention.

A further objective of the invention is to provide methods of producing an acellular matrix component of a graft that will be placed into a patient's wound. In a preferred embodiment, the invention provides a custom-produced matrix-production carrier comprising 3-D-printed material, having a structure comprising: a base, and a mold portion extending from said base, comprising a cavity duplicative in size and shape of a wound (such as, e.g., a dermal wound, a bone wound) located on a patient, such as, e.g., inventive custom-produced matrix-production carriers wherein the base consists of a 3-D-printed base and the mold portion consists of a 3-D-printed base; inventive custom-produced matrix-production carriers consisting of a 3-D-printed base and a 3-D-printed mold portion; inventive custom-produced matrix-production carriers further comprising at least one metal (such as, e.g., wherein the at least one metal is in sprayed-on or electro-coated form, and is selected from the group consisting of nickel, silver, gold, platinum, aluminum, titanium and magnesium); inventive custom-produced matrix-production carriers further comprising a plurality of spikes extending from the mold bottom portion upwards into the cavity; inventive custom-produced matrix-production carriers wherein the spikes are selected from the group consisting of plastic spikes and metal spikes; and other inventive custom-produced matrix-production carriers.

In another preferred embodiment the invention provides a custom-produced matrix-production carrier comprising a solid material selectively removable by a CNC machine, having a structure comprising: a base, and a mold portion extending from said base, comprising a cavity duplicative in size and shape of a wound located on a patient; such as, e.g., inventive custom-produced matrix-production carriers further comprising at least one metal (such as, e.g., wherein the at least one metal is in sprayed-on or electro-coated form, and is selected from the group consisting of nickel, silver, gold, platinum, aluminum, titanium and magnesium); inventive custom-produced matrix-production carriers further comprising a plurality of spikes extending from the mold bottom portion upwards into the cavity; inventive custom-produced matrix-production carriers wherein the spikes are selected from the group consisting of plastic spikes and metal spikes; and other inventive custom-produced matrix-production carriers.

The invention in another preferred embodiment provides a 3-D matrix-production carrier, comprising: a first matrix-production carrier; and a second matrix-production carrier, wherein the cavity of the first matrix-production carrier is alignable to the cavity of the second matrix-production carrier and the aligned cavities form a 3-D model of said wound, such as, e.g., inventive 3-D matrix-production carriers wherein the first matrix-production carrier is attached or affixed to the second matrix-production carrier, and the cavity in the first matrix-production carrier aligns with the cavity in the second matrix-production carrier and the aligned cavities form a 3-D model of said wound; etc.

In another preferred embodiment, the invention provides a 3-D matrix-production carrier, comprising: a set of at least two matrix-production carriers each matrix-production carrier being a custom-produced matrix-production carrier, wherein when the cavities of the matrix-production carriers are aligned, the aligned cavities form a 3-D model of said wound, such as, e.g., inventive 3-D matrix-production carriers wherein the at least two matrix-production carriers are joined together with the cavities of the matrix-production carriers aligned, with the aligned cavities having a shape of a 3-D model of the wound; etc.

### BRIEF DESCRIPTION OF THE DRAWINGS

FIG. 1 depicts a perspective view, of a back part of an embodiment of an inventive custom-produced carrier 1 having a bottom surface 2, a height dimension 1h and a bottom diameter dimension 1d.

FIG. 1A (not to scale) depicts a cross-sectional side view of carrier 1 of FIG. 1 in a spiked-bottom embodiment where bottom surface 2 comprises a plurality of spikes 2A.

FIG. 2 is an example of a line drawing that is a size and shape of a wound model, useable to produce an inventive carrier.

FIG. 3 is a photograph of an empty carrier in an inventive embodiment. FIGS. 3A-3D are photographs showing the carrier of FIG. 3 being used to contain slurry (FIG. 3A) which will undergo processing steps. As the processing occurs and the slurry changes in form, the carrier holds its shape and size (FIGS. 3-3D). In FIG. 3D, the slurry has formed into a completed matrix which is being removed with tweezers from the carrier.

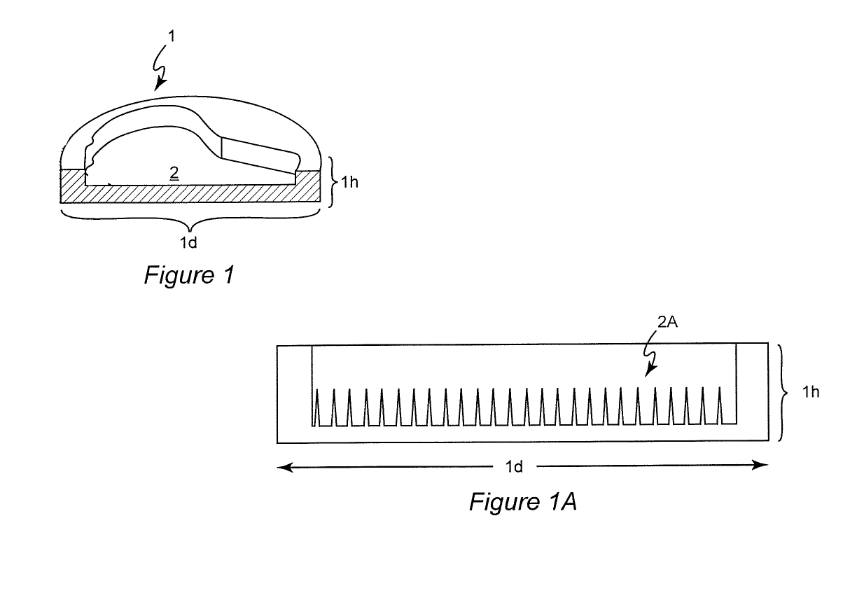

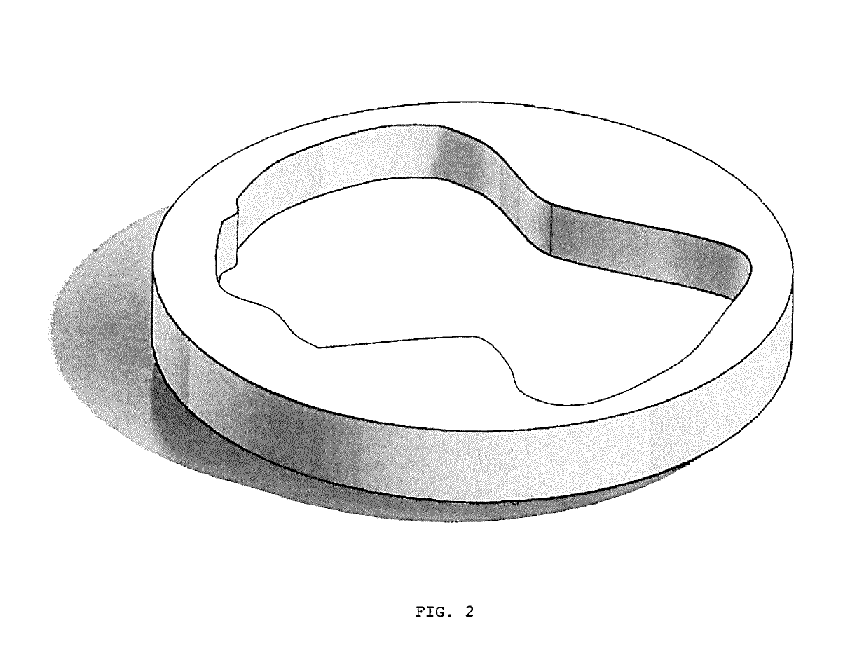

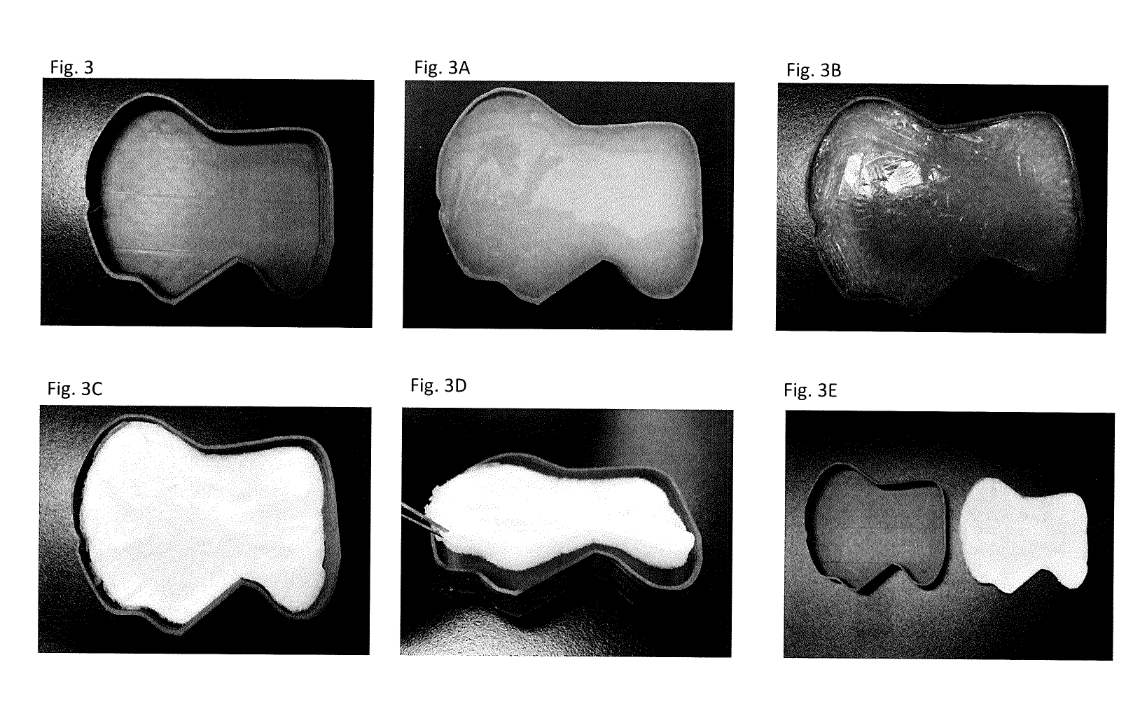

In photographic FIG. 3E, a different magnification has been used than in FIGS. 3-3D. In FIG. 3E, the completed matrix that has been removed from the carrier and the carrier are shown together. The actual size and shape of the carrier is unchanged throughout FIGS. 3-3E.

### DESCRIPTION OF A PREFERRED EMBODIMENT OF THE INVENTION

The present inventor has conceived of a custom-produced “matrix-production carrier” customized in size and shape to a specific wound. The matrix-production carrier is custom-made based on the specific wound, and then the matrix-production carrier is used to itself produce a matrix, which in turn is useable, for example, during a graft production process to receive cells and produce a graft which ultimately is received in vivo into the specific wound. As another example, the matrix is useable, alone, as an acellular graft.

In a preferred embodiment, an inventive matrix-production carrier comprises a cavity that is duplicative in shape of a wound currently suffered by one specific patient. By “duplicative in shape”, we mean that the cavity either exactly replicates the actual wound in size and shape or is a size-scaled replication of the actual wound. In a preferred embodiment in which a carrier contains a slurry which is transformed by processing into a solid that is a matrix, we consider a cavity to be duplicative in shape of a wound currently suffered by the patient for whom the inventive carrier is being produced (such as 3D-printed), when the matrix—produced by using the cavity to contain slurry during processing steps (such as processing in a lyophilization chamber)—fits into the patient's wound filling the wound volume.

For making a custom-produced matrix-production carrier, a 3-D printing process is particularly preferred. Preferred examples of 3-D-printable starting materials are ABS plastic (such as acrylonitrile butadiene styrene) and PLGA (polylactic co-glycolic acid). The starting materials are 3-D-printed into a shape duplicating the wound, using as input an image of the wound (such as a 2-D or 3-D photographed image of the wound).

Optionally, after the 3-D-printing of the 3-D-printable materials, the 3-D-printed materials can be coated through a metallization step (e.g., electroplated; electrosprayed with nickel or other non-reactive metals; sputtered; etc.) A metallized coating is an example of a coating that enhances the even distribution of heat across the surface; this is also referred to as a “conductive coating” meaning the part will conduct heat away from the matrix source material during processing. Coating of all surfaces is preferred, in order to increase conduction of heat away from the matrix during a lyophylization step when the spongiform matrix is being produced.

The inventive custom-produced matrix-production carrier comprises a cavity, the depth of which is at least the thickness of the graft matrix that is to be made using that matrix-production carrier, bearing in mind that the matrix starting material is a liquid slurry of matrix components. Examples of components of the matrix slurry are, e.g., collagen, glucosamine, hyaluronic acid, fibronectin, elastin, etc. The interior of the cavity should be constructed (such as materials used and geometric design) so that the cavity interior contains the slurry during processing steps, and permits removal of an intact finished product when processing has been completed.

As a preferred example of an overall general shape and structure of the matrix-production carrier is, e.g., a shallow mold that sits flat on a chilled shelf in a lyophilization chamber.

As an exterior bottom surface of an inventive carrier, a flat exterior bottom surface is preferred. With a flat exterior bottom surface, an inventive carrier can be stable while sitting inside a lyophilization chamber.

Depth of the cavity of the custom-produced matrix-production carrier is permitted to exceed depth of the to-be-made matrix, and in such cases, when the matrix slurry is in the cavity, there will be a “rim” or extended void area above the surface of the matrix slurry. As one example, a matrix-production carrier that is the size of one's palm of the hand, and about 0.5 inch (12.7 mm) thick, has a cavity about ¼ inch (6.3 mm) deep, and is used for making a matrix in a range of ⅛ to ¼ inch (3-6.3 mm) thick. A preferred range of heights for an inventive custom-produced carrier is from about 10 mm to 200 mm thick, more preferably, from about 10 mm to 100 mm inches thick. A preferred range of sizes for top circumferential perimeter of the inventive custom-produced cavity is about 10 mm to 600 mm, preferably about 20 mm to 300 mm. In some embodiments of the invention, the size of the carrier can be smaller than 10 mm thick and/or smaller than 10 mm in top circumferential perimeter, such as, e.g., sizes of carriers being custom-produced in connection with a wound on a pediatric human patient, sizes of carriers being custom-produced in connection with a wound on a small animal, etc. In some embodiments of the invention, the size of the carrier is not prohibited from being larger than 200 mm thick and/or having a top circumferential perimeter more than 600 mm, such as, e.g., sizes of carriers being custom-produced in connection with a sizeable wound on an especially large patient such as a very large adult human, sizes of carriers being custom-produced in connection with a wound on a large animal, sizes of carriers which are to be used to contain materials that are shrink-prone during lysophilization, etc.

An inventive matrix-production carrier can be constructed in order for its cavity to be used singly, by itself, for production of a graft matrix, or constructed in order to be used in combination with another custom-produced matrix-production carrier where the two carriers together form an enclosed cavity to be used for production of a 3-D graft matrix. The two-carrier combination approach is particularly for producing graft matrixes that are more three-dimensional, such as for treating deeper wounds. To produce a 3-D graft, two carriers are aligned so that their cavities adjoin and the adjoining cavities define the exact size and shape of the desired tissue graft, preferably without additional “rim” or void area, and the assembled pair of carriers is filled (with graft matrix slurry) through a filling port.

Examples of tissue from which the cells are obtained to use in bioprinting the matrix are, e.g., skin, bone, and other tissue, such as hepatic cells, for example.

When skin tissue is being used, a single carrier approach is preferred. The skin tissue matrix produced by the single carrier approach may be referred to as “2D”, which is used in relative terms, as the skin graft is indeed a very thin, flat 3-dimensional structure, i.e., the thickness is constant across the entire structure.

When bone grafting material is being used, for example, a paired carrier approach is preferred. Material produced using this approach may be referred to as “3-D” wherein the component has a variable topography associated with the part's thickness.

For some applications when constructing the matrix-production carrier, preferably small spike-like features are incorporated in the carrier protruding from the cavity's lower surface upward, such as by forming small tapered points during the 3-D printing. The “spikes” are believed to be important to hold the matrix in place during the lyophilization and cross-linking steps, and thereby help prevent the matrix from shrinking. Evaluating shrinkage of the matrix is critical in order for the matrix to be produced in proper size in relation to the wound cavity.

In embodiments where shrinkage cannot be avoided, namely, in which the lyophilization process decreases the size of the slurry that will form the matrix, starting with a carrier that is larger in height and perimeter than the wound's depth and wound's perimeter, is required in order to compensate for the shrinkage. For example, if a certain process of producing a matrix from a slurry is experimentally found to result in a matrix that has about 30-40% shrinkage compared to the carrier size, then the carrier will have to be made sufficiently larger than the wound so that the matrix, shrunken by 30-40%, corresponds to the wound size.

One example of 3-D printing an inventive custom-produced matrix-production carrier is to perform steps of printing a base area, and then continuing to print upper layers around a void area that corresponds to the general size and shape of the wound.

An example of how to obtain information in order to command the 3-D printer to print a certain shape is, e.g., measuring a wound at various points to determine the boundary outlines. A digital camera system with image processing software provides a quick and easy way to determine the outline is a wound area without needing to contact the wound with a ruler or other potentially non-sterile measurement tool. Advantageously, a camera system provides an easy way to determine outline shape and size of a highly irregular wound shape. Also advantageously, by usage of a camera system, a practitioner can photograph a wound at a remote location and electronically submit the image, via email or FTP for example, to a central location for 3-D printing of the matrix-production carrier.

An example that is an alternative production method to 3-D printing is, e.g., machining, such as machining a “puck” shape to form a custom-produced matrix-production carrier. With this approach, the desired carrier shape is obtained by selectively removing material from a solid core, as is the case with a Computer Numeric Control (CNC) machine.

A matrix-carrier produced according to the invention is used as follows. The matrix-carrier receives a slurry of matrix-forming materials (e.g., collagen, etc.), and a lyophilization step is carried out while the slurry is in the carrier, after which the matrix material is chemically cross-linked and the solidified matrix subsequently removed from the matrix-carrier. In some embodiments, the matrix-carrier is no longer needed after the matrix-removal and in other embodiments, the matrix-carrier is reused to make at least one additional matrix.

In some embodiments, grafts produced using matrices according to the invention duplicate grafts produced using previous matrices. In other embodiments, grafts produced using matrices according to the invention may differ from grafts produced using previous matrices.

### COMPARATIVE EXAMPLE 1

The matrix material is in the shape of a square, and is trimmed to fit the outline of a wound area. The matrix material is subsequently bioprinted, to form the graft that will be engrafted to the patient's wound.

### COMPARATIVE EXAMPLE 2

A matrix in the shape of the wound is 3-D-printed. The matrix material is subsequently bioprinted, to form the graft that will be engrafted to the patient's wound.

### INVENTIVE EXAMPLE 1

A mold of the wound's void area is 3-D-printed. The mold is used to produce a graft matrix. The graft matrix is used (such as, e.g., transferred to an incubation receptacle, populated with cells, etc.) to form the graft that will be engrafted to the patient's wound.

### INVENTIVE EXAMPLE 1A

An individual suffering from a skin wound presents in need of a skin graft. The outline of the wound, or margin of healthy tissue surrounding the wound, is determined to have an irregular shape. The wound is measured at various intervals in order to replicate the size and shape of the wound area to be covered by a graft. A matrix, which will ultimately be used to produce the graft, is first made to correspond to the wound area. The size and shape parameters are entered into a computer configured to receive the data, such as a CAD software program. The size and shape data are transformed into a 3-D carrier model and sent to a 3-D printer with capability to print a suitable material, such as PLGA or ABS. A carrier is printed according to the desired size and shape parameters, beginning with printing of a base that is larger than the wound area. For instance, if a wound is approximately 2″×4″, a base might be approximately 4″×6″. When a base reaches the desired thickness, the 3-D printer is then directed to continue printing around an area corresponding to the size and shape of the wound area. The area corresponding to the wound area represents a “void” area, which is approximately centered over the base. As layers of the printed material grow around the void area, walls around the area are built up, thus creating a cavity that replicates the size and shape of the wound. The materials are printed until the depth or volume of the cavity is at least as great as the thickness needed to produce the final graft. Thus, the depth of the cavity is determined according to the tissue of interest. In the case of a skin graft, the depth of the cavity is equal to or greater than the desired thickness for a skin graft.

### INVENTIVE EXAMPLE 1B

For an individual in need of a bone graft, particularly a portion of a bone with complex structural elements, X-ray imaging is used to reconstruct the size and shape of the desired bone graft, and the size and shape parameters are used to produce a 3-D CAD model of the two-part carrier. The data is analyzed to bisect the 3-D image at a plane that allows a two-part mold or pair of carriers to be printed using 3-D printer technology and suitable materials, such as PLGA or ABS. The pair of carriers can be assembled by aligning the cavities and temporarily affixing the two carriers together to form a unified cavity that recapitulates the 3-D size and shape of the desired graft. It is preferred that the depth of each cavity matches the “depth” of its respective bisected half of the 3-D image, i.e., there is no additional “rim” or wall extending beyond the mold area. If the height of the walls of one or both halves is found to be too high, the upper surface of the carrier may be machined, sanded, shaved or otherwise trimmed before assembly to correctly replicate the volume of the desired graft. The design also incorporates a “filling port” or aperture for instillation of a slurry of suitable matrix materials able to fill the cavity within the assembled pair of carriers.

### INVENTIVE EXAMPLE 1C

A carrier is produced according to Example 1A, with an additional feature of small spikes or tapered points printed within the cavity of the carrier. The height of the spikes depends on the depth of the cavity or thickness of the to-be-produced matrix. Spikes are placed at least near the areas representing the boundaries of the wound area, and additional spikes may be placed at intervals across the width or length of a cavity. The number of spikes may be 2-4 in a small carrier, and the number spikes may increase, but are not required to increase, as the area of the carrier increases.

### INVENTIVE EXAMPLE 1D

A spiked carrier is produced according to Example 1C. The height of the spikes does not exceed the thickness of the matrix.

### INVENTIVE EXAMPLE 1E

A spiked carrier is produced according to Example 1C. Spikes are as high as the walls of the cavity. By the spikes being high enough to penetrate the entire matrix, an orientation step can be avoided.

### INVENTIVE EXAMPLE 1F

A carrier is produced according to the method of Examples 1C, 1D or 1E. After the 3-D printing steps are completed, the carrier is subjected to a metal coating step. Some or all surfaces are coated with a metal, such as nickel or other non-reactive metal.

The above described embodiments are set forth by way of example and are not limiting. It will be readily apparent that obvious modifications, derivations and variations can be made to the embodiments. For example, the 2-D and 3-D carriers can be made of myriad materials utilizing different fabrication methods, e.g., stereo-lithographic annealing (SLA), selective laser sintering (SLS), fused deposition modeling (FDM), etc. Accordingly, the claims appended hereto should be read in their full scope including any such modifications, derivations and variations.

What we claim as our invention is as follows:

1. A custom-produced matrix-production carrier, having a structure comprising:
a base, and
a mold portion extending from said base, comprising a cavity duplicative in shape of a wound located on a patient, and having a size, by depth and perimeter, such that the wound size is in a range of about 50-100% of the cavity size.

2. The custom-produced matrix-production carrier of claim 1, wherein the cavity has a perimeter shape that is a perimeter shape of the wound.

3. The custom-produced matrix-production carrier of claim 1, wherein the wound size is in a range of about 60-100% of the cavity size.

4. The custom-produced matrix-production carrier of claim 1, wherein the wound size is in a range of about 60-70% of the cavity size.

5. The custom-produced matrix-production carrier of claim 1, wherein the base comprises 3-D printed material.

6. The custom-produced matrix-production carrier of claim 1, wherein the base consists of a 3-D-printed base and the mold portion consists of a 3-D-printed base.

7. The custom-produced matrix-production carrier of claim 1, consisting of a 3-D-printed base and a 3-D-printed mold portion.

8. The custom-produced matrix-production carrier of claim 1, further comprising at least one metal.

9. The custom-produced matrix-production carrier of claim 8, wherein the at least one metal is in sprayed-on or electro-coated form, and is selected from the group consisting of nickel, silver, gold, platinum, aluminum, titanium and magnesium.

10. The custom-produced matrix-production carrier of claim 1, further comprising a plurality of spikes extending from the mold bottom portion upwards into the cavity.

11. The custom-produced matrix-production carrier of claim 10, wherein the spikes are selected from the group consisting of plastic spikes and metal spikes.

12. The custom-produced matrix-production carrier of claim 10, wherein the spikes extend up to a top of the carrier.

13. A custom-produced matrix-production carrier according to claim 1, comprising a solid material selectively removable by a CNC machine.

14. The custom-produced matrix-production carrier according to claim 1, wherein the cavity is a cavity duplicative in shape of a dermal wound located on the patient.

15. The custom-produced matrix-production carrier according to claim 1, wherein the cavity is a cavity duplicative in shape of a bone wound located on the patient.

16. A 3-D matrix-production carrier, comprising:
a first matrix-production carrier; and
a second matrix-production carrier,
wherein the cavity of the first matrix-production carrier is alignable to the cavity of the second matrix-production carrier and the aligned cavities form a 3-D model of said wound.

17. The 3-D matrix-production carrier of claim 16, wherein the first matrix-production carrier is attached or affixed to the second matrix-production carrier, and the cavity in the first matrix-production carrier aligns with the cavity in the second matrix-production carrier and the aligned cavities form a 3-D model of said wound.

18. A 3-D matrix-production carrier, comprising:
a set of at least two matrix-production carriers each matrix-production carrier being a custom-produced matrix-production carrier according to claim 1, wherein when the cavities of the matrix-production carriers are aligned, the aligned cavities form a 3-D model of said wound.

19. The 3-D matrix-production carrier of claim 18, wherein the at least two matrix-production carriers are joined together with the cavities of the matrix-production carriers aligned, with the aligned cavities having a shape of a 3-D model of the wound.
